(19) United States
(12) Patent Application Publication
(10) Pub. No.: US 2026/0251312 A1
(43) Pub. Date: Aug. 27, 2026

(54) METHOD AND OVEN FOR PREPARING FOOD

(71) Applicant: IMMOBLES DEL SEGRIA, S.L., TORREFARRERA (Lleida) (ES)

(72) Inventors: Albert TORNÉ FICAPAL, TORREFARRERA (Lleida) (ES); Joel FARRAN SEUMA, TORREFARRERA (Lleida) (ES)

(73) Assignee: IMMOBLES DEL SEGRIA, S.L., TORREFARRERA (Lleida) (ES)

(21) Appl. No.: 19/548,334

(22) Filed: Feb. 24, 2026

(30) Foreign Application Priority Data
Feb. 25, 2025 (EP) 25382169.8

(51) Int. Cl. F24C 7/08; F24C 7/02; F24C 15/32

(52) U.S. Cl. CPC F24C 7/087; F24C 7/02; F24C 15/322

(57) ABSTRACT

The present disclosure provides an oven and a method for preparing food. The method disclosed herein adapts the parameters of a cooking process according to the number of portions. In particular, the method comprises: introducing a number (N) of portions into a cooking chamber (2), the oven (1) comprising a convection fan (8) and a microwave generator (5), the number (N) of portions being equal to or greater than 1; determining a convection temperature (T); determining a cooking time (t), as a function of the number (N) of portions introduced into the cooking chamber (2); determining a power (P) of the microwave generator (5), depending on the number (N) of portions; determining a speed (v) of the convection fan (8), depending on the number (N) of portions; and preparing the food by applying the determined convection temperature (T), cooking time (t), power (P) of the microwave generator (5) and speed (v) of the convection fan (8).

### CROSS-REFERENCE TO RELATED APPLICATIONS

This application claims the priority benefit of European Patent Application No. 25382169.8, filed Feb. 25, 2025, which is incorporated herein by reference in its entirety.

### OBJECT OF THE INVENTION

The present invention relates to a method and an oven for preparing food, which allows, given a cooking process in progress, to simultaneously execute another cooking process.

### BACKGROUND OF THE INVENTION

There is a type of ovens known as combined ovens, which use convection and microwaves to regenerate food quickly. These ovens, also called high-speed ovens, are professional appliances that combine multiple heating technologies to cook, reheat or brown food quickly and efficiently.

This type of oven is used in the food industry, especially in restaurants, bakeries and fast-food outlets, but is also gaining popularity in the domestic market due to its versatility and speed.

Although these ovens can be used to cook food, they are generally used to regenerate food that has already been cooked and previously refrigerated to bring it to the optimum serving temperature. These thermal regeneration processes usually last from seconds to a few minutes.

A high-speed oven uses a combination of cooking methods to achieve optimum results in less time than conventional ovens. The main technologies include:
Conduction, in which the food is placed on a preheated cooking base, which transfers energy to the food by conduction;
Forced convection, in which a fan directs a flow of hot air at high speed over the food.

This ensures even browning and crispness on the surface of the food, for example, the temperature usually reaches a temperature between 200° C. and 300° C., depending on the model.

Furthermore, a microwave oven generates microwave energy that penetrates food to heat it quickly from the inside, which is ideal for drastically reducing cooking time without compromising external texture.

This combination of energy transfer technologies to the food allows for shorter thermal regeneration times of the food compared to a conventional oven. They also allow for crispy textures, unlike a conventional microwave oven. Therefore, they allow the food to regenerate in temperature at a high speed, while maintaining the organoleptic qualities of the food.

However, the regeneration of multiple rations in combined ovens poses challenges related to:
Uneven browning: A constant flow of air at high speed may over-brown the outer surfaces when the cooking time increases to cater for a larger quantity of food. Indeed, in order to optimally heat several portions, the regeneration time will have to be extended. However, this may over-brown the surface of the food.
Inconsistent heating: When adding more portions, parameters need to be adjusted to ensure that each portion receives an adequate amount of thermal energy (either by conduction or convection) and microwave energy.
Excessive time: Cooking multiple portions without an optimized setting can result in unnecessarily long cooking times or poor quality results.

### SUMMARY OF THE INVENTION

Therefore, an objective of the present invention is to provide a method and an oven for preparing food which adapts the parameters of a cooking depending on the number of portions, ensuring a homogeneous result. At in particular, it automatically adjusts the cooking time, the microwave power and the speed of the convection fan, leaving the chamber temperature fixed, depending on the cooking parameters previously entered for a portion, and the number of portions entered by the user at the time of cooking, optimizing the final result and maintaining a homogeneous quality regardless of the volume of food.

With the method and oven for preparing food of the invention, the aforementioned disadvantages are solved, presenting other advantages that will be described below.

The method and oven for preparing food according to the present invention are described in the corresponding independent claims, and the dependent claims include additional features which are optional.

In particular, the method for preparing food comprises the following steps:
introducing a number of food portions into a cooking chamber of an oven, the oven comprising a convection fan and a microwave generator, and the number of portions being equal to or greater than 1;
determining a convection temperature, the convection temperature being fixed;
determining a cooking time, depending on the number of portions placed in the cooking chamber, which increases as the number of portions increases;
determining the power of the microwave generator, depending on the number of portions placed in the cooking chamber, the higher the number of portions, the higher the power of the microwave generator;
determining a convection fan speed, depending on the number of portions introduced into the cooking chamber, with the speed decreasing as the number of portions increases; and
preparing the food by setting the convection temperature, the cooking time, the power of the microwave generator and the convention speed.

Advantageously, the cooking time is calculated according to the following formula:

$${t}_{N} = {t}_{1} \cdot ( 1 + {K}_{t} \cdot ( N - 1 ) )$$

where:
N: Number of portions placed in the cooking chamber;
t₁: Base time for one ration;
Kₜ: Proportional time increment factor with a range between 0 and 1.

Advantageously, the microwave generator power is calculated according to the following formula:

$${P}_{N} = MIN ( {P}_{1} \cdot ( 1 + {K}_{P} \cdot ( N - 1 ) ) , {P}_{MAX} )$$

where:
N: number of portions placed in the cooking chamber;
K_{P}: Proportional power increase factor with a range between 0 and 1;
P₁: Microwave base power for one portion.
P_{MAX}: Maximum microwave power of the oven.

Advantageously, the convection fan speed is calculated according to the following formula:

$${v}_{N} = {v}_{1} \cdot ( 1 - {K}_{v} \cdot ( N - 1 ) )$$

where:
N: number of portions placed in the cooking chamber;
v₁: Base speed of the convection fan for one portion;
Kᵥ: Inversely proportional fan speed decrement factor with a range between 0 and 1.

In addition, the oven for preparing food comprises:
a cooking chamber for introducing a number of portions, where the number of portions is equal to or greater than 1;
a convection fan;
a microwave generator; and
a control electronics which performs the method for preparing food described above.

With the method and oven according to the present invention the following advantages are achieved, among others:

### Consistent Results:

It ensures that each portion, regardless of the number of portions, receives the same heat and microwave treatment, avoiding differences in quality.

### Operational Efficiency:

It automatically adjusts the parameters to optimize time and energy depending on the number of portions, with no additional user intervention other than repeatedly pressing the recipe to be executed.

### Homogeneous Browning:

The progressive reduction of the fan speed ensures that the browning remains uniform even with longer cooking times.

### Simplicity of Use:

Once the cooking parameters for a portion have been created, the user only has to indicate the number of portions, while the oven automatically adapts all the parameters.

### BRIEF DESCRIPTION OF THE DRAWINGS

For a better understanding of what has been explained above, some drawings are included in which, schematically and only by way of a non-limiting example, a practical case of embodiment is shown.

FIG. 1 is a schematic side view of the oven for preparing food according to the present invention.

### DESCRIPTION OF THE INVENTION

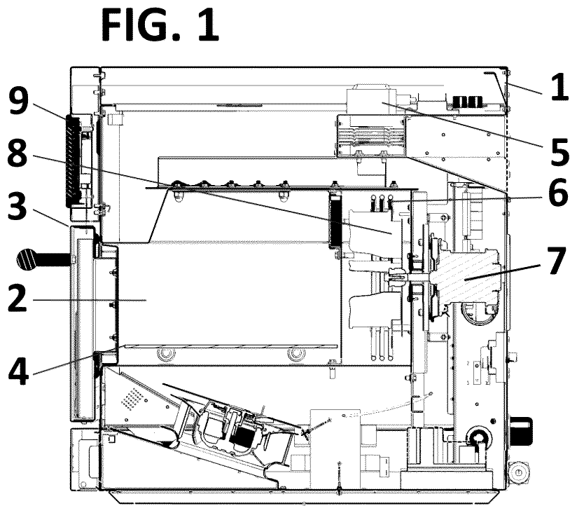

FIG. 1 shows the oven according to the present invention, indicated in general by reference number 1, comprising a cooking chamber (2) accessible through a door (3), a cooking tray (4), a microwave generator (5), a heat generating resistor (6), a variable speed convection motor (7) linked to a turbine (8) inside the cooking chamber and control electronics (9), which automatically adjusts the cooking parameters according to the number of portions (N) specified by the user, as explained below.

These cooking parameters include:
Convection temperature (T): Remains fixed regardless of the number of portions.
Cooking time (t): Increases with increasing number of servings to compensate for higher heat load.
Convection fan speed (v): Decreases as cooking time increases to prevent overcooking.
Microwave power (P): Increases as the number of portions increases to compensate for the higher heat load. This power value P is limited to the maximum microwave power of the oven.

It should be noted that the parameters related to fan speed or microwave power can be given either absolutely, e.g. 4200 rpm or 1000 W, or as a percentage of the maximum (100% of 4200 rpm or 30% of 1000 W).

Given a specific food portion cooking parameters (T, t, P, v), the user is allowed to specify the number of portions N introduced into the oven, and automatically adapts the variable parameters (t, P, v) while keeping the predefined convection temperature (T) constant for homogeneous cooking of the portions.

First, the cooking parameters are entered by the user, in particular, the user enters via an interface, e.g. a display in the oven, the cooking parameters for a food ration. These parameters (T, t, P, v) allow a single food ration to be regenerated.

Hereafter, subscript 1 will be used to refer to the cooking parameters of one portion (T₁, t₁, P₁, v₁), subscript 2 to refer to the cooking parameters of two portions (T₂, t₂, P₂, v₂), etc.).

Once the user has entered the cooking parameters, cooking starts.

When cooking more than one portion, the user inserts all the portions into the cooking chamber of the combined oven at the same time. Once they have been entered, he/she indicates the appliance how many portions (N) he/she has entered via the graphic interface. For example, two short presses would indicate two portions, three short presses three portions, and so on. The value of N is used as input for a scaling algorithm.

An automatic adjustment of the parameters is then performed, and the following rules are implemented to calculate the parameters as a function of N:

### Cooking Time (t):

The time is increased according to the following formula:

$${t}_{N} = {t}_{1} \cdot {K}_{t} \cdot ( N - 1 ) )$$

where:
t₁: Base time for 1 ration (e.g. 1 minute);
Kₜ: Proportional time increment factor with a range between 0 and 1 (e.g. 0.15).

The value Kₜ is configurable by the manufacturer in the technical service menu. For example, a factor of 0.15 may give good results for all types of cookings. However, it can be adjusted to optimise the result if the cooking spectrum is more limited.

### Microwave Power (P):

The power increases with the number of portions according to the following formula:

$${P}_{N} = MIN ( {P}_{1} \cdot ( 1 + {K}_{P} \cdot ( N - 1 ) ) , {P}_{MAX} )$$

### Where:

K_{P}: Proportional power increase factor with a range between 0 and 1 (e.g. 0,2);
P₁: Microwave base power for one portion (e.g. 500 W).
P_{MAX}: Maximum microwave power of the oven (e.g. 1000 W).

The value K_{P} is configurable by the manufacturer in the technical service menu. For example, a factor of 0.1 gives good results for all cookings. However, it can be adjusted to optimize the result if the cooking spectrum is more limited.

### Convection Fan Speed (v):

The initial fan speed (v₁) decreases with N to avoid excessive browning due to increased time, according to the following formula:

$${v}_{N} = {v}_{1} \cdot ( 1 - {K}_{v} \cdot ( N - 1 ) )$$

where:
v₁: Base speed of the convection fan for 1 portion (e.g. 4200 rpm);
Kᵥ: Inversely proportional fan speed decrement factor with a range between 0 and 1 (e.g. 0.1).

The value Kᵥ is configurable by the manufacturer in the technical service menu. For example, a factor of 0.1 gives good results for all cookings. However, it can be adjusted to optimise the result if the cooking spectrum is more limited.

The convection temperature (T) is a fixed parameter and is kept constant throughout the process, ensuring a stable reference for browning and cooking.

Several non-limiting examples of use of the method according to the present invention are provided below.

### Example 1: One Portion (N=1)

Temperature: T=275° C.
Time: t₁=1.0 minute=1:00
Power: P₁=500 W=50% if we assume that the maximum power is 1000 W
Speed: v₁=4200 rpm=100% if we assume that the maximum speed is 4200 rpm

### Example 2: Two Portions (N=2)

Temperature: T=275° C.
Time: t₂=1.0·(1+0.15·(2−1))=1.15 minutes=1:09
Power: P₂=MIN (500·(1+0.1·(2−1)), 1000)=550 W=55% if we assume that the maximum power is 1000 W.
Speed: v₂=4200·(1−0.1·(2−1))=3780 rpm=90 assuming a maximum speed of 4200 rpm

### Example 3: Three Portions (N=3)

Temperature: T=275° C.
Time: t₃=1.0·(1+0.15·(3−1))=1.3 minutes=1:18
Power: P₃=MIN (500·(1+0.1·(3−1)), 1000)=600 W=60% if we assume that the maximum power is 1000 W
Speed: v₃=4200·(1−0.1·(3−1))=3360 rpm=90% assuming a maximum speed of 4200 rpm.

The following table summarizes, as a non-limiting example only, the cooking parameters for 1, 2, 3 and 4 portions of food.

| Portions (N) | Temperature (T) | Time (t) | Power (P) | Speed (v) |
|---|---|---|---|---|
| 1 | 275° C. | 1.0 min | 500 W | 4200 rpm |
| 2 | 275° C. | 1.15 min | 550 W | 3780 rpm |
| 3 | 275° C. | 1.3 min | 600 W | 3360 rpm |
| 4 | 275° C. | 1.45 min | 650 W | 2940 rpm |

To simplify the display and input of data by the user, it is possible to express power and speed in terms of maximum power and maximum speed. Thus, if the maximum power is 1000 W and the maximum speed is 4200 rpm, the table could be expressed analogously as follows:

| Portions (N) | Temperature (T) | Time (t) | Power (P) | Speed (v) |
|---|---|---|---|---|
| 1 | 275° C. | 01:00 (mm:ss) | 50% | 100% |
| 2 | 275° C. | 01:09 (mm:ss) | 55% | 90% |
| 3 | 275° C. | 01:18 (mm:ss) | 60% | 80% |
| 4 | 275° C. | 01:27 (mm:ss) | 65% | 70% |

Although reference has been made to a specific embodiment of the invention, it is obvious to a person skilled in the art that the method and oven described are susceptible to numerous variations and modifications, and that all the details mentioned can be replaced by technically equivalent ones, without departing from the scope of protection defined by the appended claims.

1. A method for preparing food, characterized in that it comprises the following steps:
introducing a number (N) of food portions into a cooking chamber (2) of an oven (1), the oven (1) comprising a convection fan (8) and a microwave generator (5), and the number (N) of portions being equal to or greater than 1;
determining a convection temperature (T), this temperature being fixed;
determining a cooking time (t), as a function of the number (N) of portions introduced into the cooking chamber (2), being longer as the number (N) of portions increases;
determining a power (P) of the microwave generator (5), depending on the number (N) of portions introduced in the cooking chamber (2), being higher as the number (N) of portions increases;
determining a speed (v) of the convection fan (8), as a function of the number (N) of portions introduced into the cooking chamber (2), being lower as the number (N) of portions increases; and
preparing the food by applying the determined convection temperature (T), cooking time (t), power (P) of the microwave generator (5) and speed (v) of convention (8).

2. The method for preparing food according to claim 1, wherein the cooking time (t) is calculated according to the following formula:
$${t}_{N} = {t}_{1} \cdot {K}_{t} \cdot ( N - 1 ) )$$
wherein
N is Number of portions placed into the cooking chamber (2);
t₁ is a Base time for one portion; and
Kₜ is a proportional time increment factor with a range between 0 and 1.

3. The method for preparing food according to claim 1, wherein the power (P) of the microwave generator is calculated according to the following formula:
$${P}_{N} = MIN ( {P}_{1} \cdot ( 1 + {K}_{P} \cdot ( N - 1 ) ) , {P}_{MAX} ) ,$$
wherein
N is number of portions placed in the cooking chamber (2);
K_{P} is proportional power increase factor with a range between 0 and 1;
P₁ is microwave base power for one portion; and
P_{MAX} is maximum microwave power of the oven.

4. Method for preparing food according to claim 1, wherein speed (v) of the convection fan (8) is calculated according to the following formula:
$${v}_{N} = {v}_{1} \cdot ( 1 - {K}_{v} \cdot ( N - 1 ) ) ,$$
wherein
N is number of portions placed in the cooking chamber (2);
v₁ is base speed of the convection fan for one portion;
Kᵥ is inversely proportional fan speed decrement factor with a range between 0 and 1.

5. Oven (1) for preparing food, comprising:
a cooking chamber (2) for the introduction of a number (N) of portions, where the number (N) of portions is equal to or greater than 1;
a convection fan (8);
a microwave generator (5); and
a control electronics (9) that performs the method for preparing food according to claim 1.
